(19) United States
(12) Patent Application Publication
(10) Pub. No.: US 2006/0176780 A1
(43) Pub. Date: Aug. 10, 2006

(54) Winding stem positioning plate-like structural body and electronic timepiece possessing the same

(76) Inventor: Tamotsu Ono, Chiba-shi (JP)

Correspondence Address: BRUCE L. ADAMS, ESQ., SUIT E 1231, 17 BATTERY PLACE, NEW YORK, NY, 10004, US

(21) Appl. No.: 11/313,350

(22) Filed: Dec. 21, 2005

(30) Foreign Application Priority Data
Dec. 28, 2004 (JP) 2004-380858

(51) Int. Cl. G04B 29/00

(52) U.S. Cl. 368/319

(57) ABSTRACT

To provide a winding stem positioning plate-like structural body capable of suppressing an occupation space to a lowest limit, and an electronic timepiece possessing the same. A winding stem positioning plate-like structural body of an electronic timepiece 1 has a plate-like base body part which is disposed to a machine casing of a timepiece main body under a state that its main face forms an angle with a main face of the timepiece main body, and which is held by an engaging part of the machine casing of the timepiece main body, and an elastic winding stem engaging arm part which extends from one end edge in a thickness direction of the machine casing within the base body part to the thickness direction of the timepiece main body and an extension direction of the main face of the timepiece main body, which engages with a small diameter axle part adjoining a bead-like part of a winding stem in a winding stem engaging part of a tip, and which allows a transit of the bead-like part 27 by being elastically deformed in an F2 direction by the bead-like part when the winding stem is put in and out in A1, A2 directions.

### BACKGROUND OF THE INVENTION

1. Field of the Invention

The present invention relates to a winding stem positioning plate-like structural body, and an electronic timepiece possessing the same.

2. Description of the Prior Art

It is known to make such that, when pulling out a winding stem in order to rotate a hand and when thereafter pushing the winding stem, a positioning of the winding stem is performed and a click feeling is given to a user. It is also known to make such that that, for this positioning of the winding stem and this bestowal of the click feeling, a bead-like large diameter part is formed in the winding stem, an engagement part is elastically engaged with a small diameter part located adjacently to the bead-like large diameter part and, when the winding stem is put in and out, the engagement part is relatively moved from the small diameter part, in one end side, of the bead-like part to the small diameter part in the other end side beyond the bead-like part.

In a conventional electronic timepiece, for this positioning of the winding stem and this bestowal of the click feeling, one part of a metal-made plate-like body which spreads along a machine casing of a timepiece main body in a direction along an extension face of the time piece main body and which functions as a battery plus terminal has been bent in a thickness direction of the timepiece main body under a state acting as a plate spring, a large diameter hole part has been formed in a thickness direction extension part formed by this bending, and it has been loosely fitted to the small diameter part located adjacently to the bead-like large diameter part (for example, JP-A-2004-93534 Gazette).

However, a conventional winding stem positioning structural body of this kind, since it is necessary to cause one part of the plate-like part which has spreaded along the extension face of the machine casing to function as the plate spring, it is necessary to comparatively, largely ensure a space that a deformation of the plate spring requires for bending in the thickness direction, so that a utilization efficiency of a narrow space in a timepiece case has been bad. As a result, a shape and a disposition (layout) of the winding stem positioning structural body, a shape of the machine casing, and the like have been restricted, and also a degree of freedom concerning, a layout and the like of timepiece components have become low.

The present invention is one made in view of the above-mentioned points, and its object is to provide a winding stem positioning plate-like structural body capable of suppressing an occupation space to a lowest limit, and an electronic timepiece possessing the same.

### SUMMARY OF THE INVENTION

In order to achieve the above object, a winding stem positioning plate-like structural body of the present invention has a plate-like base body part which is disposed to a machine casing of a timepiece main body under a state that its main face forms an angle with a main face of the timepiece main body, and which is held by an engaging part of the machine casing, and an elastic winding stem engaging arm part which extends from one end edge in a thickness direction of the machine casing within the base body part to a thickness direction of the timepiece main body and an extension direction of the main face of the timepiece main body, which engages with a small diameter axle part adjoining a bead-like part of a winding stem in a winding stem engaging part of a tip, and which allows a transit of the bead-like part by being elastically deformed by the bead-like part when the winding stem is put in and out.

In this winding stem positioning plate-like structural body, since the plate-like base body part is disposed to the machine casing of the timepiece main body under the state that its main face forms the angle with the main face of the timepiece main body, and the elastic winding stem engaging arm part extends from one end edge in the thickness direction of the machine casing within the base body part to the thickness direction of the timepiece main body and the extension direction of the main face of the timepiece main body and engages with the small diameter axle part adjoining the bead-like part of the winding stem in the winding stem engaging part of the tip, an elastic deformation of the elastic winding stem engaging arm part occurs in a thickness direction (extension direction of a face of the base body part) of the timepiece main body practically in an extension face of the structural body, so that, even if the base body part consists of a comparatively thin plate-like body, the base body part can possesses a sufficient rigidity against a force applied to the winding stem engaging arm part in an extension direction of the base body part face and, therefore, not only the elastic deformation can be localized to the winding stem engaging arm part but also a space required for a disposition and an operation of the winding stem positioning plate-like structural body can be suppresses to the lowest limit. Accordingly, not only a size of the timepiece main body can be made the lowest limit but also a degree of freedom in a layout of timepiece components is liable to be increased.

Here, typically, the base body part is disposed such that its main face becomes perpendicular to the main face of the timepiece main body. However, so long as it can be deemed that the elastic deformation of the winding stem engaging arm part occurs practically in extension faces of the base body part and the arm part, it may somewhat deviate from a perpendicular direction.

In a winding stem positioning plate-like structural body of the present invention, although the whole of the winding stem engaging arm part in a longitudinal direction may comprises an elastic portion, typically, the elastic winding stem engaging arm part possesses an elastic arm main body part extending from one end edge in the thickness direction of the machine casing within the base body part to the thickness direction of the timepiece main body and the extension direction of the main face of the timepiece main body, and a winding stem engaging part which has been formed in a tip of the arm main body part in order to engage with the small diameter axle part adjoining the bead-like part of the winding stem, and which allows the transit of the bead-like part when the arm main body part has been elastically deformed.

In a winding stem positioning plate-like structural body of the present invention, typically, the winding stem engaging part possesses a concave portion engaged with one side in an outer periphery of the small diameter axle part of the winding stem, or possesses a ring-like portion loosely fitted to the small diameter axle part of the winding stem.

In a case possessing the concave portion, if the winding stem is put in and out, by the fact that the elastic arm main body part is elastically deformed such that an opening side of an arc-like portion moves away from a center axis of the winding stem, the concave portion allows a movement of the bead-like part. In the case comprising the concave portion, since an engagement can be released by bending the arm main body part such that the concave portion is displaced to a bottom wall side of the concave portion, an engagement/disengagement of the winding stem can be easily performed. Typically, although it is arc-like, it may be other shape such as U-shaped or V-shaped one. Typically, although the concave portion faces on a train wheel bridge side, it may faces on a main plate side if desired.

In a case possessing the ring-like portion, if the winding stem is put in and out, by the fact that the elastic arm main body part is elastically deformed such that a portion having butted against the small diameter axle part within the ring-like portion moves away from the center axis of the winding stem (such that a center of the ring-like portion approaches the center axis of the winding stem), the ring-like portion allows a movement of the bead-like part.

In a winding stem positioning plate-like structural body of the present invention, typically, although the plate-like base body part which is disposed to the machine casing of the timepiece main body under the state that its main face forms the angle with the main face of the timepiece main body, and which is supported by the engaging part of the machine casing may be directly supported or indirectly supported by the machine casing so long as being disposed calmly to the machine casing of the timepiece main body, it is constituted typically so as to be supported by the machine casing of the timepiece main body while being nipped in groove parts or between protrusion parts of the machine casing of the timepiece main body. The protrusion parts may be oppositely disposed or may be zigzag disposed. The protrusion part may support the base body part under a line contact (point contact when seen from a direction perpendicular to the main face of the timepiece main body) state like a pin, or may support the base body part under a face contact (line contact when seen from the direction perpendicular to the main face of the timepiece main body) state. In this case, typically, since the base body part becomes in its main face substantially perpendicular to the main face of the timepiece main body and can extend in the extension direction of the main face of the timepiece main body, it can be disposed and supported under a predetermined state even if not fixed by screws, caulking and the like. Accordingly, the occupation space of the holding structure of the machine casing can be suppressed to the lowest limit as well.

Incidentally, even if the base body part of the plate-like structural body is directly held by a side wall of the groove part or the protrusion part of the machine casing under a state having been nipped in groove parts or between protrusion parts of the machine casing of the timepiece main body, it may be adapted such that, under the state having been nipped in groove parts or between protrusion parts of the machine casing of the timepiece main body, it is held for the first time by the fact that an end part is elastically pushed to a battery, a crystal can and the like under a loosely fitted state.

Incidentally, in order to support the plate-like base body part against a force, in the thickness direction of the timepiece main body, that the winding stem engaging arm part undergoes from the winding stem when putting in and out the winding stem, it may be adapted such that an end edge in the thickness direction of the plate-like base body part is locked by the protrusion part, of the machine casing, located in a corresponding side.

Further, in order to support the winding stem engaging arm part itself against a force, in a longitudinal direction of the winding stem, that the winding stem engaging arm part undergoes from the winding stem when putting in and out the winding stem, there may be formed a restriction wall part in which the winding stem engaging arm part is loosely fitted in the thickness direction. The restriction wall part can be formed, for example, in opposite side walls of the groove parts or one part of the plural protrusion parts, which constitute the engaging part of the machine casing, and the like.

In an electronic timepiece possessing a winding stem positioning structural body of the present invention, the base body part possesses in its one end a battery pushing plate spring part for pushing a battery, and possesses in its the other end a crystal oscillator case body pushing plate spring part for pushing a crystal oscillator case body. By this, not only a large crystal oscillator and the battery among timepiece components can be certainly pushed but also a retention of the base body part of the winding stem positioning structural body can be more stably performed. Incidentally, typically, the winding stem positioning plate-like structural body consists of a metal-made plate spring, and functions as a battery plus terminal. Accordingly, it becomes a simple structure of the battery plus terminal, and its manufacture becomes easy as well.

Further, in an electronic timepiece possessing a winding stem positioning structural body of the present invention, typically, the plate-like structural body possesses a reset lever biasing spring part for biasing a reset lever to a reset position in one end edge in the thickness, direction of the timepiece main body. In this case, it becomes possible to form the reset lever practically by a rigid body. Further, in this case, from the fact that the reset lever biasing spring part extends in a direction (typical perpendicular direction) intersecting a rotation face of the reset lever, a shape of the spring part can be simplified, and an operation is liable to be stabilized. In this case, the reset lever has, typically, a bearing part or axle part rotatably supported with respect to the machine casing of the timepiece main body, a winding stem butting part undergoing a pushing force of the winding stem (typically, an end face or side face of a tip part of the winging stem), a reset terminal part butted against a reset pin and the like when rotated to a reset position, and a spring receiving part engaged with the reset lever biasing spring part, and these portions are formed as a monolithic rigid structural body. Since this reset lever is not necessary to substantially possess a spring function, from the fact that a degree of freedom in a material and a size is largely increased and it becomes practically possible to be formed by a simple punched sheet metal body, it is easy to be manufactured and a manufacturing cost can be suppressed to the lowest limit as well. Incidentally, from the fact that the winding stem butting part undergoes the pushing force of the winding stem, although it may have an elasticity in some degree, since the elasticity is ensured practically by the reset lever biasing spring part, it may be far higher in its rigidity than the reset lever biasing spring part.

### BRIEF DESCRIPTION OF THE SEVERAL VIEWS OF THE DRAWINGS

A preferred form of the present invention is illustrated in the accompanying drawings in which:

FIG. 1 is a plan explanatory view of a main body part (under a state that a train wheel bridge has been removed) of an electronic timepiece of one preferred embodiment, of the present invention, possessing a plate spring structural body as a winding stem positioning plate-like structural body of one preferred embodiment of the present invention;

FIG. 2 is a sectional explanatory view along a II-II line of FIG. 1;

FIG. 3 is a sectional explanatory view along a III-III line of FIG. 1;

FIG. 4 is a perspective explanatory view of the plate spring structural body of FIG. 1;

FIG. 5 is a plan explanatory view when the electronic timepiece of FIG. 1 exists in a non-reset state;

FIG. 6 is a plan explanatory view when the electronic timepiece of FIG. 1 exists in a reset state; and

FIG. 7 is a sectional explanatory view, similar to FIG. 3, of the plate spring structural body as the winding stem positioning plate-like structural body possessing an elastic winding stem engaging arm part of a modified example.

### DETAILED DESCRIPTION OF THE PREFERRED EMBODIMENTS

Next, one preferred implementation mode of the present invention is explained on the basis of one preferred embodiment shown in the appended drawings.

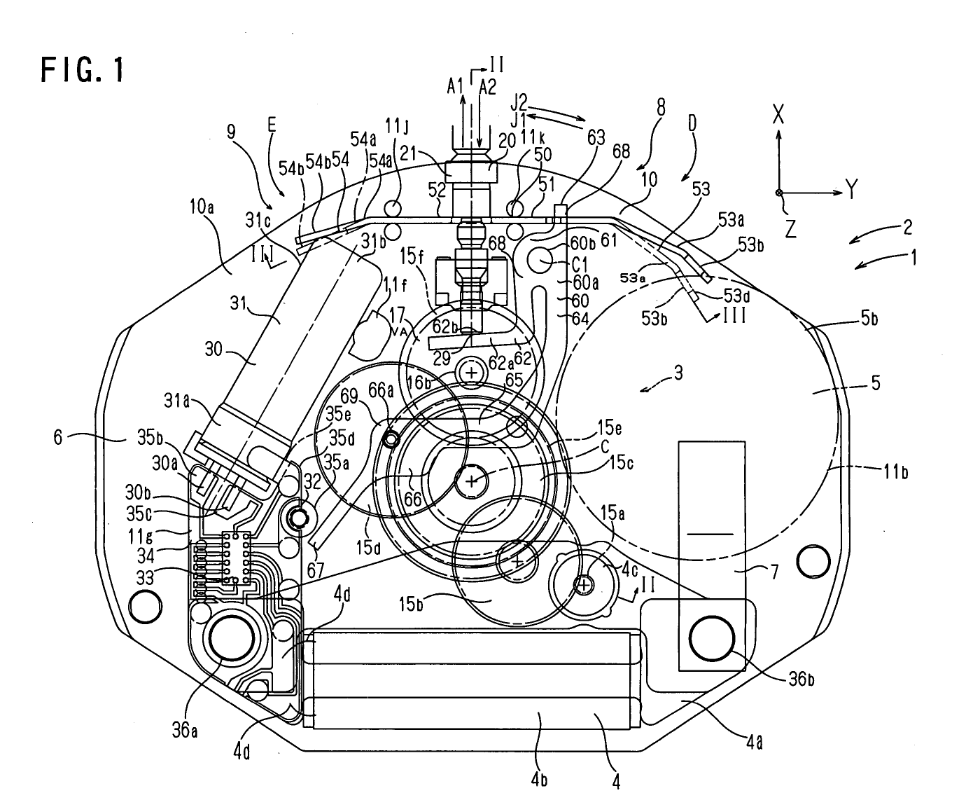

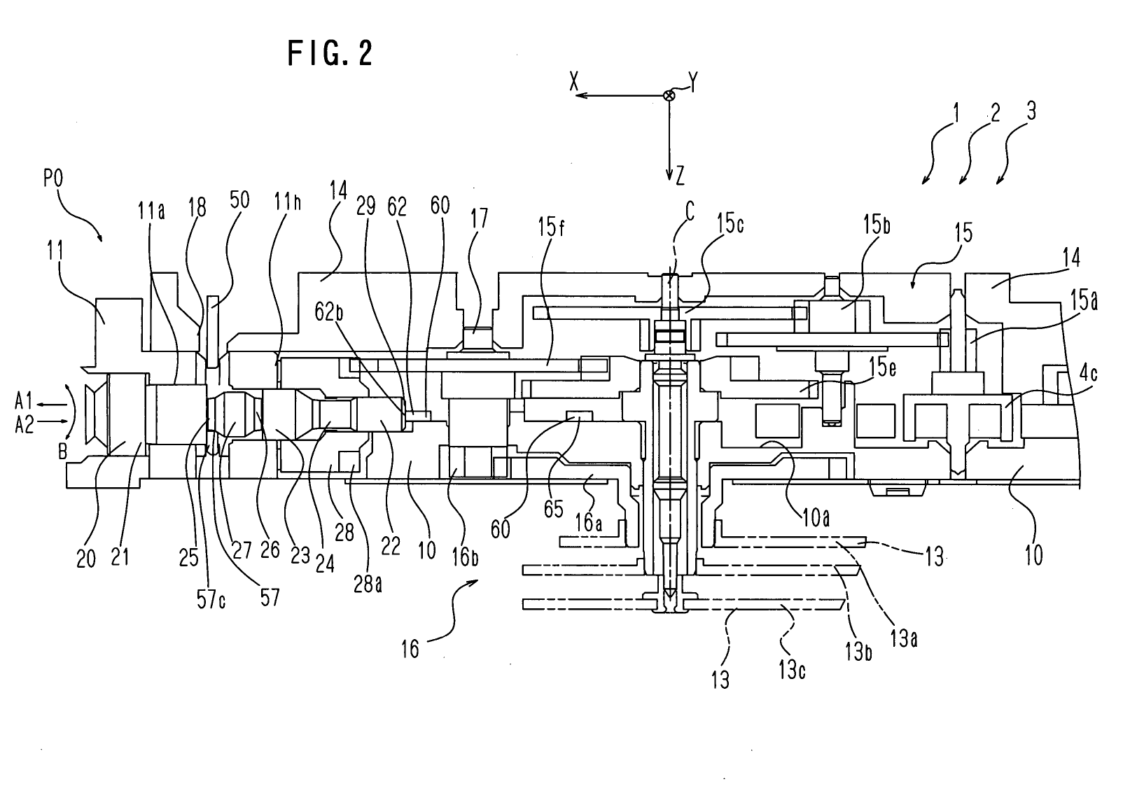

A timepiece main body 2 of an electronic timepiece 1 possesses a main plate 10 constituting a machine casing. Hereunder, for a simplification of the explanation, there is adopted a three-dimensional orthogonal coordinate system fixed to the main plate 10. Here, a pulling-out direction A1 (3 o'clock side) of a winding stem 20 is made an X direction, a right direction (12 o'clock side) in FIG. 1 is made a Y direction, and a direction deep in the drawing and perpendicular to the drawing is made a Z direction. The Z direction coincides with a side where a dial 12 (refer to FIG. 2) exists. Here, an XY plane is parallel to a main face of the timepiece main body 2, and the direction of a Z axis is a direction perpendicular to the main face of the timepiece main body 2. In FIG. 11 and FIG. 2, C is a rotation center axis of time display hands 13 (i.e., hour hand 13a, minute hand 13b, second hand 13c) connected to a train wheel mechanism 3 of the timepiece main body 2. Here, the timepiece main body 2 indicates a portion excluding an armor portion such as case from the timepiece 1.

The main plate 10 possesses irregularities and a shape, which are suitable for a disposition/support of various timepiece elements to be positioned to respective positions of a −Z side surface 10a of the main plate 10. The main plate 10 has a side wall 11 (FIG. 2) possessing a winding stem guiding hole 11a in a 3 o'clock side position, and possesses a crystal oscillator case body (crystal can) receiving protrusion part 11f protrusively provided in a −Z side surface 10a, a flexible circuit board mounting protrusion part 11g, plate spring center side edge receiving protrusion parts 11j, 11k, a battery accommodating concave part 11b whose one part of a peripheral wall has been defined by a clutch wheel receiving concave part 11h and the side wall 11, which have been formed in the surface 10a, and the like, and so forth. Incidentally, within the surface 10a of the main plate 10, in an approximately 5 o'clock direction of the hand when seen from the center axis C, there is additionally provided a reset pin 32. A position of the reset pin 32 may be other position in dependence on depositions and shapes of a circuit board 34 mentioned later and the like.

The winding stem 20 penetrating through the winding stem guiding hole 11a of the main plate 10 possesses, in addition to a large diameter axle part 21 in a base end side, a prismatic engaging axle part 22 in a tip, a columnar medium diameter axle part 23 in an intermediate, a columnar small diameter axle part 24 between the axle parts 22, 23, and a bead-like part 27 whose both sides in A1, A2 directions have been defined by small diameter axle parts 25, 26, and is fitted to a clutch wheel 28. The clutch wheel 28 possessing a medium diameter hole part in the base end side and an angular, tubular hole part in a tip (deep) side is located in a clutch wheel receiving concave part 11h of the main plate 10, and fitted to the winding stem 20 among the axle parts 22, 24, 23. In a case where the winding stem 20 exists in a 0 stage position (normal position) pushed in the A2 direction, the medium diameter hole part and the angular, tubular hole part of the clutch wheel 28 are rotatably fitted respectively to the medium diameter axle part 23 and the small diameter axle part 24 of the winding stem 20. On the other hand, in a case where the winding stem 20 exists in a 1st stage position (pulled-out position) pulled out by one stage in the A1 direction, the angular, tubular hole part of the clutch wheel 28 is engaged with the prismatic engaging axle part 22 in the tip of the winding stem 20, and the clutch wheel 28 is rotated in compliance with a rotation of the winding stem in a B direction. The clutch wheel 28 is meshed with an eighth wheel gear 15f by a wheel gear part 28a in a tip.

As understood from FIG. 1 and FIG. 2, the train wheel mechanism 3 contains a front side train wheel 15 located between the main plate 10 and a portion of a train wheel bridge 14 located with a space being left in a −Z direction with respect to the main plate 10, and a back side train wheel 16 located in a +Z side of the main plate 10. The train wheel bridge 14 can be deemed to be one part of the machine casing similarly to the main plate 10. The front side train wheel 15 contains a sixth wheel & pinion 15a, a fifth wheel & pinion 15b, a second wheel & pinion (second wheel) 15c, a third wheel & pinion 15d, a center wheel & pinion (minute wheel) 15e and the eighth wheel gear 15f, and the back side train wheel 16 contains an hour wheel (hour wheel) 16a and an eighth pinion 16b. An axle or case band of an eighth wheel & pinion (minute wheel) 17 extends while penetrating through the main plate 10 in the Z direction, the eighth wheel gear 15f is provided in a side of the front train wheel 15, and the eighth pinion 16b is provided in a side of the back side train wheel 16. Within an axle of the third wheel & pinion 15d, an axle part in a side adjoining the main plate 10 is fitted to a bearing hole 66a of a reset lever 60 mentioned later.

In FIG. 1, within the surface 10a of the main plate 10, in a position in a side opposite to the winding stem 20, i.e., 9 o'clock side, there is disposed a motor 4 elongated in the Y direction. In FIG. 1, in a right side of the winding stem 20 and the motor 4, a button type battery 5 is disposed in the battery accommodating concave part 11b whose one part of the peripheral wall has been defined. Further, in FIG. 1, in a left side of the winding stem 20 and the motor 4, there is disposed a circuit block 6 containing the flexible circuit board 34 mounted with an IC (Integrated Circuit) 33 for the timepiece, and a crystal oscillator 30. In compliance with a desire, circuit components other than the IC 33 are also mounted to the board 34.

The motor 4 contains a stator 4a, a coil block 4b and a rotor 4c, and a rotor pinion constituting the sixth wheel & pinion 15a is formed in an axle of the rotor 4c. The coil block 4b of the motor 4 is electrically connected to the flexible circuit board 34 by extension parts 4d of a winding.

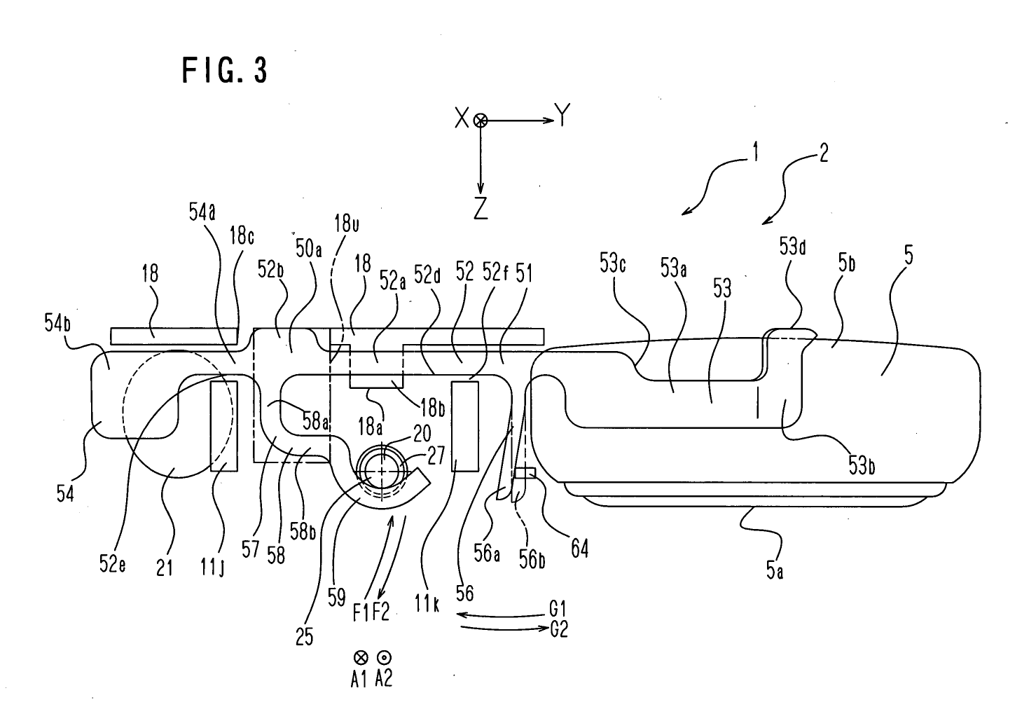

36a, 36b are connection parts for mechanically, monolithically connecting the stator 4a and the coil block 4b. In a place of the connection part 36a, the circuit board 34 is fixed to the motor 4 and, in a place of the connection part 36b, a battery minus terminal 7 is fixed to the motor 4. The connection parts 36a, 36b possess in their center an opening, a protrusion protrusively provided from the main plate 10 is fitted and thermally caulked to the opening, and the whole of the motor 4, the circuit board 34 and the like are fixed to the main plate 10. The battery minus terminal 7 extends in a +Z side of the battery 5 along the surface 10a of the main plate 10, and contacts with a negative electrode 5a (FIG. 3) in an end face of the battery 5 mounted on the surface 10a of the main plate 10. The battery minus terminal 7 is electrically connected to the circuit board 34 through the motor 4 (for example, a core insulated to windings of the stator member 4a and the coil block 4b, and the like), and gives a minus electric potential of the battery 5 to the circuit board 34. That is, a conductive portion itself of a component of the motor 4 cooperates with the battery minus terminal 7, thereby becoming an electric supply line in a minus side of an electric source.

A −Z side end part in the axle part of the rotor 4c of the motor 4 is rotatably supported in the train wheel bridge 14. The large diameter coil block 4b of the motor 4 protrudes in a −Z direction, and may be fitted loosely to a corresponding notch or opening of the train wheel bridge 14 (not shown in the drawing), or pushed by the train wheel bridge 14. Similarly. also the battery 5 whose height is high in the −Z direction is fitted loosely to a corresponding battery attaching/detaching opening (not shown in the drawing) of the train wheel 14. In a case where a use in a range of life of the battery 5 is presupposed, there may be adapted such that the battery 5 is pushed by the train wheel bridge 14.

Within a +Z side surface of the flexible circuit board 34 of the circuit block 6, in a center-side side edge of the timepiece main body 2, there is formed a reset pin connecting conductive pad part 35a and, when the flexible circuit board 34 has been mounted on a main plate protrusion part 11g of a plane shape practically the same as the board 34 in an example shown in the drawing, the conductive pad part 35a just butts against a −Z side end face (top face) of the reset pin 32. Incidentally. as to the protrusion part 11g, so long as it can support the flexible circuit board 34 with a desired stability, of course its shape may differ from the flexible circuit board 34. Incidentally, under a state that the train wheel bridge 14 has been attached, the train wheel bridge 14 pushes the conductive pad part 35a of the circuit board 34 to the top face of the reset pin 32. However, an electrical connection between the reset pin 32 and the circuit board 34 may be realized by a different form.

In the circuit block 6, there are additionally formed conductive patterns 35b, 35c, 35d, and a connection terminal piece part 35e is attached to the conductive pattern 35d. The conductive pattern 35d is connected to an electric supplying terminal of an electric source voltage (electric potential) Vdd of the IC 33 for the timepiece, and the conductive patterns 35b, 35c are connected to terminals of the crystal oscillator 30. One pair of connection pins or connection terminal parts 30a, 30b of the crystal oscillator 30 are electrically connected and fixed to the conductive patterns 35b, 35c by soldering. The connection terminal piece part 35e electrically connected in its base end to the conductive pattern 35d extends along the surface 10a of the main plate 10, and contacts with a +Z side portion in a peripheral face of a conductive can, i.e., a base end part 31a of a crystal can 31, as a case body of the crystal oscillator 30 mounted on the surface 10a of the main plate 10.

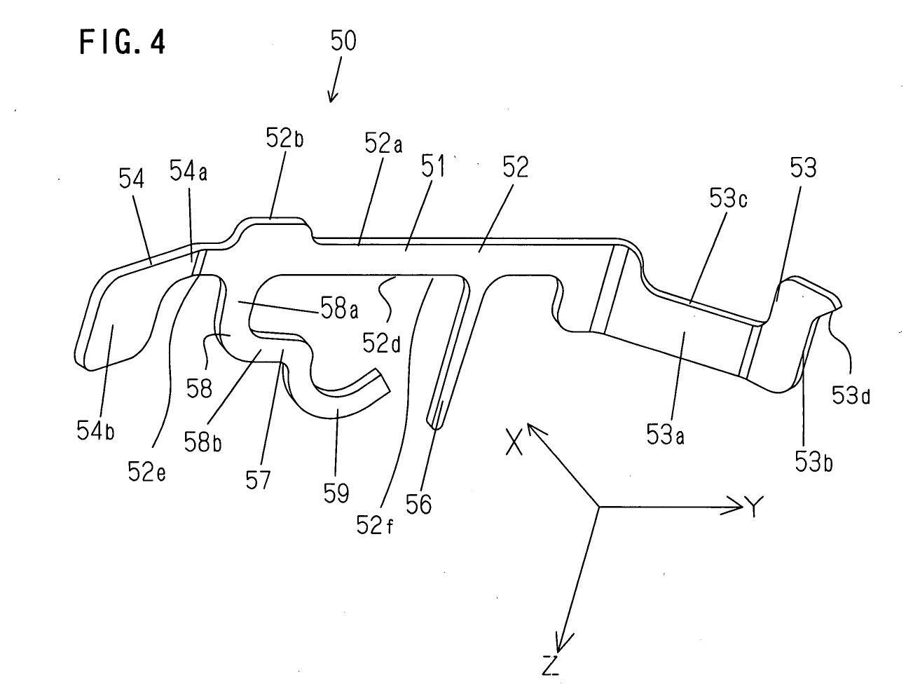

In the train wheel bridge 14, there is formed a groove 18 (FIG. 2) as an engaging part and, in the groove 18, there is locked a metal-made plate spring structural body 50 as the winding stem positioning plate-like structural body. As shown in FIG. 3 and FIG. 4 in addition to FIG. 1 and FIG. 2, a main face or surface of the plate spring structural body 50 is perpendicular to an XY plane. That is, a normal line to the main face of each part of the plate spring structural body 50 is located in a face parallel to the XY plane irrespective of a direction of the main face.

As understood from FIG. 1, FIG. 3 and FIG. 4, the plate spring structural body 50 has a main body part 51 as a plate-like base body part extending approximately in the Y direction along the timepiece main body 2. The plate spring main body part 51 possesses a center part 52 as a base body part extending in the Y direction, a battery plus electrode contact terminal part 53 which extends to a −X side in a slanting direction at an obtuse angle with respect to the center part 52 from a +Y direction end part of the center part 52 and whose tip is elastically pressure-contacted to a peripheral face constituting one, part of a plus electrode 5b of the battery 5, and a crystal can contact terminal part 54 which extends to the −X side in the slanting direction at the obtuse angle with respect to the center part 52 from a −Y direction end part of the center part 52 and whose tip is elastically pressure-contacted to a side edge 31c of a tip part 31b of the crystal can 31 as a crystal oscillator case body. The plate spring structural body 50 comprises a stainless alloy plate whose thickness is about 0.15-0.2 mm for instance. Of course, the thickness and the material may differ.

The battery plus electrode contact terminal part 53 contains a slanting arm part 53a extending to the −X side in the slanting direction at the obtuse angle with respect to the center part 52 from the +Y direction end part of the center part 52, and a battery plus electrode contact part 53b extending slantingly to the −X side at a more obtuse angle from a tip of the slanting arm part 53a, and is pressure-contacted to the battery plus electrode 5b in a tip part of the battery plus electrode contact part 53b. A bent angle of the contact part 53b with respect to the center part 52 is less than 90 degrees as a whole. In this example, the center part 52 becomes widened in the Z direction in the vicinity of a +Y direction end part, and the battery plus electrode contact terminal part 53 is partially notched in its side edge 53c in a −Z side. Incidentally, by the fact that the contact part 53b in the tip of the battery plus electrode contact terminal part 53 stands up in a −Z direction and additionally possesses a tip part 53d straight extending forward from the standing-up end part (FIG. 3), a wide contacting region is ensured with respect to the battery plus electrode 5b.

The crystal can contact terminal part 54 possesses a narrow arm part 54a and a crystal can contact part 54b widely formed in a tip part of the arm part 54a in the Z direction, and is pressure-contacted to the side edge 31c of the tip part 31b of the crystal can 31 by the contact part 54b.

Accordingly, by the fact that the plate spring structural body 50 contacts with the plus electrode 5b of the battery 5 by the battery plus electrode contact terminal part 53 and contacts with the crystal can 31 by the crystal can contact terminal part 54, it functions as a battery plus terminal for directly giving a voltage (electric potential) of the plus electrode 5b of the battery 5 to an electric source terminal of the IC 33 through the connection terminal piece part 35e and the conductive pattern 35d as the electric supply line.

Incidentally, since the plate spring structural body 50 having such structure and shape as mentioned above is formed by being bent at 90 degrees or less and in one direction as a whole with respect to the center part 52, a formation of bending die therefor and a bending operation can be performed in a cost and a time, which are lowest limits.

As shown in FIG. 3, the plate spring structural body 50 is fitted to a groove 18b of a protrusion part 18a of the engaging part 18 of the train wheel bridge 14 in a center region 52a of the center part 52, and fitted to an opening part 18c of the train wheel bridge 14 in a protrusion part 52b formed in a side edge in the −Z side of the center part 52.

The center part 52 of the plate spring structural body 50 may be supported between, for example, one pair of protrusion parts (pin-like objects for instance), instead of the groove part 18b. Incidentally, the groove part and the protrusion part may be formed in the main plate 10 or formed in both of the train wheel bridge 14 and the main plate 10, instead of being formed in the train wheel bridge 14.

Incidentally, the plate spring center side edge receiving protrusion parts 11j, 11k protruding in the −Z direction are formed in the surface 10a of the main plate 10, and a side edge part 52d (FIG. 3) in a +Z side of the center part 52 of the spring structural body 50 is supported at places 52e, 52f where it does not interfere with other displacement element in both sides of a winding stem engaging spring part 57 explained below, thereby prohibiting a displacement of the center part 52 to the +Z direction.

The plate spring structural body 50 has additionally a reset lever biasing spring part 56 protruding from a side edge part in the +Z side, and a winding stem engaging spring part 57 as an elastic winding stem engaging arm part. The winding stem engaging spring part 57 contains a basal side arm part 58a extending in the +Z direction from a main body part 51, a tip side arm part 58b extending in the +Y direction from an extension end of the basal side arm part 58a, and an arc-like engaging part 59 corresponding to a concave portion as a winding stem engaging part extended from a tip of the arm part 58b, and is elastically engaged with the small diameter part 25 or 26 in the vicinity of the bead-like part 27 of the winding stem 20 by the arc-like engaging part 59. Here, an arm main body part 58 comprises the basal side arm part 58a and the tip side arm part 58b.

Since this plate spring structural body 50 extends in the Y direction as a whole and consists of a plate spring possessing a width in the Z direction, an area occupying in the X-Y plane can be suppressed to the lowest limit. Further, since it can be held only by being inserted into the groove part 18b or the like and does not require a fixing structure such as screw fixing and caulking, a space required for the holding can be suppressed to the lowest limit as well.

As understood from FIG. 1 and FIG. 3, the plate spring structural body 50 is engaged with the engaging part 18 of the train wheel bridge 14 in the center part 52 and supported by the train wheel bridge 14, the battery plus electrode contact terminal part 53 located in a ty direction end part is elastically pressure-contacted in a D direction to a peripheral face of a positive electrode 5b of the battery 5, and the crystal can contact terminal part 54 located in a −Y direction end part is elastically pressure-contacted in an E direction to the side edge 31c of the tip part 31b of the crystal can 31 supported by the crystal oscillator case body receiving protrusion part 11f of the main plate 10 (if desired, there may be adapted so as to additionally support a side edge of a base end side end face or a base end part of the crystal can 31). Accordingly, since the plate spring structural body 50 can elastically press down the battery 5 and the crystal oscillator 30 with the engaging part 18 of the train wheel bridge 14 being made a supporting point, both of the battery 5 and the crystal oscillator 30, whose size is large in comparison with other component and whose mounting stability is liable to become bad, can be simultaneously, stably positioned and fixed. Further, since the plate spring structural body 50 contacts in its one end with the battery 5 under a large contact pressure and is contacting in its the other end with the crystal can 31 of the crystal oscillator 30 under the large contact pressure, it is possible to certainly transmit a plus electric potential of the battery 5 to the crystal can 31. Moreover, since the crystal can 31 is connected to an electric source voltage supply terminal of the IC 33 of the circuit block 6 through the contact terminal piece part 35e and the conductive pattern 35d, it is possible to directly utilize the case body of the crystal oscillator 30, i.e., the crystal can 31, for the supply of the electric source voltage. Since the crystal oscillator case body part or the crystal can 31 occupies a large volume or area in the main body part 2 of the electronic timepiece 1, a length of the battery plus terminal is suppressed to the lowest limit.

Further, in the arc-like engaging part 59 of the winding stem engaging spring part 57, since the spring structural body 50 is engaged with the small diameter parts 25, 26 in both sides of the bead-like part 27 of the winding stem 20 and is applying an elastic force in an F1 direction to the winding stem 20, it is possible to stably, elastically hold the winding stem 20 elastically engaged with the spring part 57 in the small diameter parts 25 and 26 without position-deviating in the A1, A2 directions, thereby positioning the winding stem 20. Further, since the engagement of the spring part 57 with the small diameter parts 25 and 26 is an elastic engagement, in a case where the winding stem 20 is pulled out, e.g., in the A1 direction when the winding stem 20 exists in the 0 stage position and the arc-like engaging part 59 of the spring part 57 is engaged with the small diameter part 25 of the winding stem 20, it follows that the bead-like part 27 is moved in the A1 direction by being elastically deformed such that the arc-like engaging part 59 of the spring part 57 is pushed down in an F2 direction by the bead-like part 27 whose diameter is larger than the small diameter part 25. If the bead-like part 27 passes through the spring part 57 in the A1 direction, the arc-like engaging part 59 of the spring part 57 is deformed again in the F1 direction by an elastic restoring force, and fits to the small diameter part 26. By this, when pulling out the winding stem 20 in the A1 direction, the spring part 57 of the spring structural body 50 cooperates with the bead-like part 27, thereby giving the click feeling. Also when pushing the winding stem 20 in the A2 direction from the winding stem 1st stage to the winding stem 0th stage, since it follows that, after the engaging part 59 of the spring part 57 has been deformed so as to allow a transit of a maximum diameter part of the bead-like part 27 from the small diameter part 26, it fits to the small diameter part 25, a similar click feeling is obtained.

Incidentally, on the occasion of such a support of the spring part 57 as mentioned above, since it follows that the spring structural body 50 is not only held by the engaging part 18 of the train wheel bridge 14 but also supported through the both end spring parts 53, 54 by the battery 5 and the crystal can 31 as a reaction of elastically pushing the battery 5 and the crystal can 31 in the both end parts 53, 54, the support of the winding stem 20 can be stabilized under a stably held state.

Further, in this electronic timepiece 1, since the protrusion parts 11j, 11k of the surface 10a of the main plate 10 are supporting in the −Z direction the side edge part 52d (FIG. 3) in the center part 52 of the spring structural body 50 in both sides of the winding stem engaging arm part 57, it is possible to certainly prohibit the displacement of the center part 52 to the +Z direction, so that the spring part 57 can certainly give the click feeling. Incidentally, so long as it is possible to support the spring part 57 while certainly prohibiting the displacement of the center part 52 of the spring structural body 50 in the +Z direction, support positions, numbers and shapes of the protrusion parts 11j, 11k may differ. If desired, it may be adapted such that plural grooves 18b are previously formed in the train wheel bridge 14 and, after inserting the spring structural body 50 into the grooves 18b, +Z side opening parts of the grooves 18b are closed or narrowed by a heat caulking and the like before an incorporation of the train wheel bridge 14.

Additionally, when putting in and out the winding stem 20, in order to support the winding stem engaging arm part 58 itself against a force, in the longitudinal direction X of the winding stem 20, that the winding stem engaging arm part 58 undergoes from the winding stem 20, in a place shown by imaginary lines 18u in FIG. 3 there may be formed one pair of restriction wall parts 18u to which the winding stem engaging arm part 58 is loosely fitted in the thickness direction X.

In this example, although the winding stem 20 possesses one bead-like part 27 and in its both sides there are possessed one pair of small diameter axle parts 25, 26, in a case where the winding stem has pulling-out positions of two stages, the winding stem 20 possesses two bead-like parts. In that case, between the two bead-like parts, of course one small diameter axle part can be used in common.

Further, so long as the arc-like engaging part 59 of the winding stem engaging part engages in its concave inside part with the small diameter axle parts 25, 26 of the winding stem 20 and can allow the displacement of the bead-like part 27 in the axial directions A1, A2, it may be a U-shaped, V-shaped or other shape which is so large as to approximate to the opening part, instead of being curved like the arc. Incidentally, the engaging part 59 may be an arc-like shape possessing a concave part in the +Z side and elastically pushed toward the +Z direction from the −Z side of the winding stem 20, instead of being the arc-like shape possessing the concave part in the −Z side and elastically pushed toward the −Z direction from the +Z side of the winding stem 20.

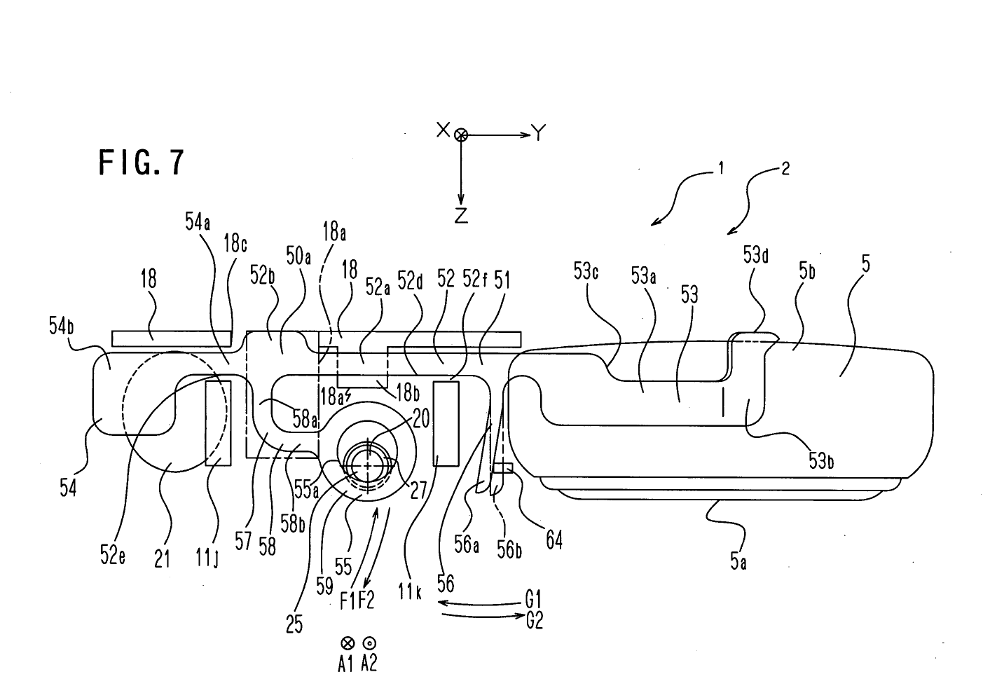

Additionally, as shown in FIG. 7, the winding stem engaging part may comprises a ring-like engaging part 55 possessing a large diameter hole part 55a, instead of the arc-like engaging part 59 as a concave engaging part. Here, the large diameter hole part 55a has a size capable of allowing a transit of the bead-like part 27 to the A1, A2 directions in a case where it has been coaxially disposed while being loosely fitted to the small diameter axle parts 25, 26 and loosely fitted to the large diameter bead-like part 27, and is elastically engaged with the small diameter axle parts 25, 26 in an inner peripheral wall part in the +Z side. However, in a case acting no external force, it may be adapted so as to be engaged in the inner peripheral face in the −Z side. It may be apparent that an elastic winding stem engaging arm part 57a possessing this ring-like engaging part 55 in a tip of the elastic arm part 58 functions similarly to the elastic winding stem engaging arm part 57 shown in FIG. 3 and the like. A plate spring structural body 50a, as the winding stem positioning plate-like structural body, having this elastic winding stem engaging arm part 57a of FIG. 7 is constituted similarly to the plate spring structural body 50 and similarly functions in practice, except a point possessing the ring-like engaging part 55 instead of the arc-like engaging part 59.

The electronic timepiece 1 additionally possesses the reset lever 60 as a reset lever main body part. In this example, the reset lever 60 possesses a plate-like part 60a consisting of a punched sheet metal body of a shape like a sea horse as a whole, and an axle part 60b for rotatably supporting the plate-like part 60a with respect to the main plate 10 about a rotation center axis C1 in a center part. The axle part 60b may be rotatably supported in a bearing hole of the main plate 10, and alternatively the plate-like part 60a may be rotatable with respect to the axle part 60b.

The reset lever plate-like part 60a has an L-shaped arm part 62 extending to a place of a tip of the winding stem 20 from a center boss part or stout part 61 spreading in a region containing the rotation center axis C1, a spring receiving part or engaging protrusion part 63 protruding in the X direction from the boss part 61 and engaging with the spring part 56, a vertical direction arm part 64 extending approximately in the −X direction from the boss part 61, a lateral direction arm part 65 extending approximately in the −Y direction from an extension end, of the vertical direction arm part 64, extending slightly slantingly, a third wheel & pinion bearing stout part or boss part 66 formed in a tip of the arm part 65, and a reset terminal part 67 slantingly extending from the boss part 66 to a place of the reset pin 32. In the above, the boss part 61, the L-shaped arm part 62 and the engaging protrusion part 63 constitute an input side lever part 68, and the arm parts 64, 65, 67 and the boss part 66 constitute an output side lever part 69. Further, in the above, a reset lever unit 8 comprises the reset lever 60, and the spring part 56 of the plate spring structural body 50. Incidentally, it may be deemed that the reset lever unit 8 comprises the reset lever 60, and the plate spring structural body 50 possessing the spring part 56.

In a case where the winding stem 20 exists in a winding stem 0th stage P0 pushed in the A2 direction, a side edge 62b of a position detecting arm part 62a in a tip side of the L-shaped arm part 62 of the reset lever 60 is pushed in the A2 direction from a tip face 29 of the winding stem 20. In order to avoid an excessive A1 direction reaction force from acting on the winding stem 20, although typically the L-shaped arm part 62 can somewhat deflect, it has a rigidity far higher than the reset lever biasing spring part 56 of the plate spring structural body 50 and can be deemed to be a rigid body so long as being compared with the spring part 56.

Further, in the case where the winding stem 20 exists in the winding stem 0th stage P0 pushed in the A2 direction, the spring receiving part or engaging protrusion part 63 of the reset lever 60 is pushed in the −Y direction to a side edge 56b in the +Y side of tip part 56a of the reset lever biasing spring part 56 of the plate spring structural body 50, thereby elastically deforming the biasing spring part 56 so as to shift the tip part 56a of the reset lever biasing spring part 56 in a G1 direction (solid lines in FIG. 3).

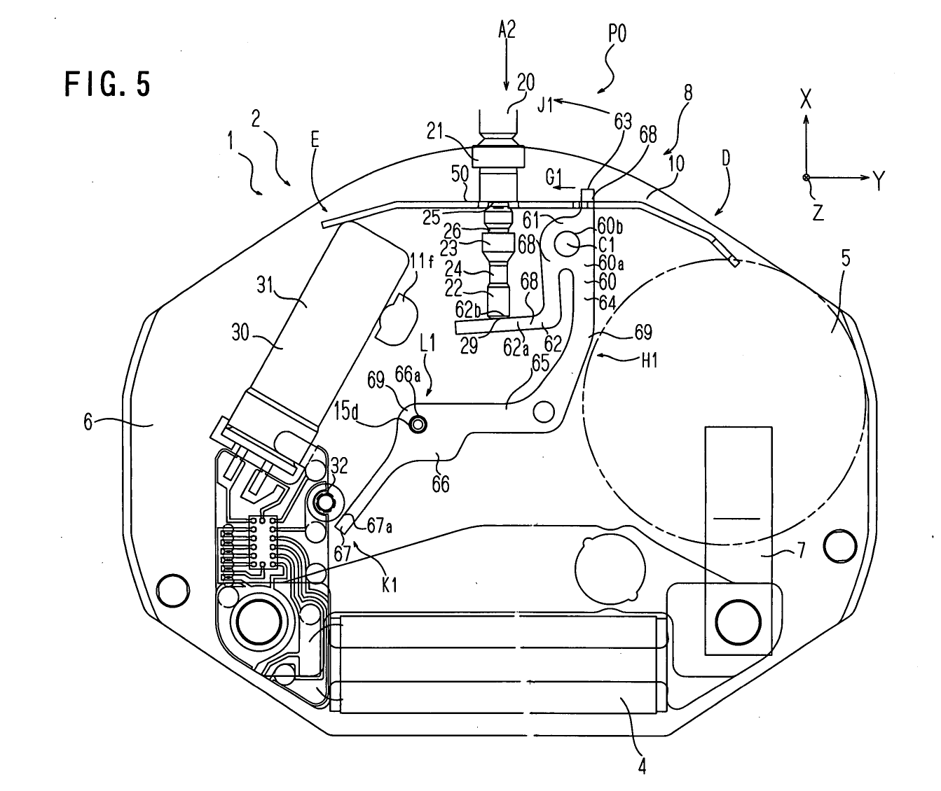

Accordingly, in the case where the winding stem 20 exists in the winding stem 0th stage, the reset lever 60 takes a non-reset position H1 as shown in FIG. 5. That is, in the case where the winding stem 20 exists in the winding stem 0th stage, the input side lever part 68 is rotation-displaced in a J1 direction under an action of a pushing force in the A2 direction by the tip face 29 of the winding stem 20, thereby pushing the spring part 56 of the plate spring structural body 50 to the G1 direction. An output side lever 69 of the reset lever 60 is also rotation-displaced in the J1 direction, and the reset terminal part 67 takes a non-reset position K1 where a side edge 67a of its tip has separated from the reset pin 32. Incidentally, in the case where the reset lever 60 takes the non-reset position H1, a third wheel & pinion support bearing part 66a takes an engaging position L1, and a third wheel & pinion 15d meshes with the center wheel & pinion 15e, thereby transmitting a rotation of the second wheel & pinion 15c to the center wheel & pinion 15e.

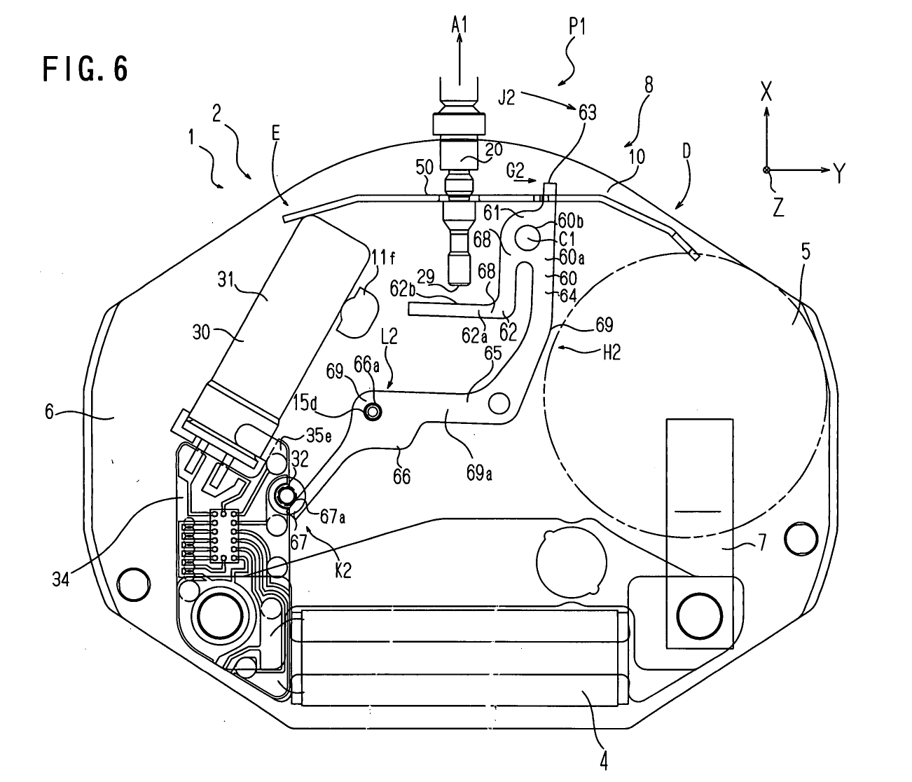

On the other hand, as shown in FIG. 6, if the winding stem 20 is pulled out in the A1 direction and takes a winding stem 1st stage position P1, the tip face 29 of the winding stem 20 moves in the A1 direction, and separates from the side edge 62b of the position detecting arm part 62a of the L-shaped arm part 62 of the reset lever 60. Accompanying a release of rotation displacement force in the J1 direction with respect to the input side lever part 68, the input side lever part 68 is rotated in a J2 direction about the center axis C1 by the elastic restoring force, in a G2 direction, that the spring part 56 of the plate spring structural body 50 applies to the protrusion part 63. Accordingly, the output side lever part 69 is also rotation-displaced in the J2 direction, and the reset terminal part 67 is pushed to the reset pin 32 in the tip side edge part 67a of the tip. That is, if the winding stem 20 is pulled out in the A1 direction and takes the winding stem 1st stage position P1, the reset lever 60 takes a reset position H2, and there is set a reset position K2 where the reset terminal part 67 butts against the reset pin 32. As a result, a supply of driving signal from the circuit block 6 to the motor 4 is stopped, a rotation of the motor 4 is stopped, and a rotation of the second hand 13c is stopped. Incidentally, if the reset lever 60 takes the reset position K2, the third wheel & pinion support bearing part 66a takes a non-engaging position L2, a mesh between the third wheel & pinion 15d and the center wheel & pinion 15e is released, and a rotation of the center wheel & pinion (minute wheel) 15e becomes not transmitted to the second wheel & pinion (second wheel) 15c. About details of a method itself of supporting an axle of the third wheel & pinion by the reset lever 60, there is disclosed in the JP-A-2004-93534 Gazette for instance. Incidentally, instead of adapting such that the mesh between the third wheel & pinion 15d and the center wheel & pinion 15e is released by a displacement by the third wheel & pinion support bearing part 66a, it may be adapted such that a mesh between the third wheel & pinion 15d and the second wheel & pinion 15c is released.

If the mesh between the third wheel & pinion 15d and the center wheel & pinion 15e is released, although a rotation of the winging stem 20 for a hand rotation is transmitted from the clutch wheel 28 to the hour wheel (hour wheel) 16a and the center wheel & pinion (minute wheel) 15e through the minute wheel 17, since the rotation is not transmitted to the second wheel & pinion (second wheel) 15c, hand settings of the minute hand 13b and the hour hand 13a can be performed under a state that the second hand 13c has been stopped.

In the above, the plate spring structural body 50 may comprise a 1st plate spring structural body possessing the 1st plate spring main body part 51, the battery plus electrode contact terminal part 53, the crystal can contact terminal part 54 and the reset lever biasing spring part 56, and a 2nd plate-like structural body (winding stem positioning plate-like structural body) possessing a 2nd plate-like base body part and the elastic winding stem engaging arm part 57. In that case, instead of the 1st plate spring structural body, the 2nd plate-like structural body may possess additionally the battery plus electrode contact terminal part 53 and the crystal can contact terminal part 54 or the reset lever biasing spring part 56.

What is claimed is:

1. A winding stem positioning plate-like structural body comprising:
a plate-like base body part which is disposed to a machine casing of a timepiece main body under a state that its main face forms an angle with a main face of the timepiece main body, and which is held by an engaging part of the machine casing; and
an elastic winding stem engaging arm part which extends from one end edge in a thickness direction of the machine casing within the base body part to a thickness direction of the timepiece main body and an extension direction of the main face of the timepiece main body, which engages with a small diameter axle part adjoining a bead-like part of a winding stem in a winding stem engaging part of a tip, and which allows a transit of the bead-like part by being elastically deformed by the bead-like part when the winding stem is put in and out.

2. A winding stem positioning plate-like structural body according to claim 1, wherein the elastic winding stem engaging arm part possesses:
an elastic arm main body part extending from one end edge in the thickness direction of the machine casing within the base body part to the thickness direction of the timepiece main body and the extension direction of the main face of the timepiece main body, and
a winding stem engaging part which has been formed in a tip of the arm main body part in order to engage with the small diameter axle part adjoining the bead-like part of the winding stem, and which allows the transit of the bead-like part when the arm main body part has been elastically deformed.

3. A winding stem positioning plate-like structural body according to claim 1, wherein the winding stem engaging part possesses a concave portion engaged with one side in an outer periphery of the small diameter axle part of the winding stem.

4. A winding stem positioning plate-like structural body according to claim 1, wherein the winding stem engaging part possesses a ring-like portion loosely fitted to the small diameter axle part of the winding stem.

5. A winding stem positioning plate-like structural body according to claim 1, wherein the base body part has an elongated shape extending in the extension direction of the timepiece main body, and the engaging part of the machine casing comprises groove parts or plural protrusion parts, by which the base body part is held while being nipped.

6. A winding stem positioning plate-like structural body according to claim 1, disposed in the timepiece main body such that the main face becomes substantially perpendicularly to the main face of the timepiece main body.

7. An electronic timepiece having a winding stem positioning plate-like structural body according to claim 1, wherein the base body part possesses in its one end a battery pushing plate spring part for pushing a battery, and possesses in its the other end a crystal oscillator case body pushing plate spring part for pushing a crystal oscillator case body.
